(19) United States
(12) Patent Application Publication
(10) Pub. No.: US 2005/0227358 A1
(43) Pub. Date: Oct. 13, 2005

(54) Methods of determining a quality of an array substrate

(76) Inventors: John F. McEntee, Boulder Creek, CA (US); Joseph Vandenburg, Mountain View, CA (US); Brent T. Tolosko, Santa Clara, CA (US); Nelson R. Holcomb, Palo Alto, CA (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 10/817,566

(22) Filed: Apr. 1, 2004

(51) Int. Cl. G01N 21/00

(52) U.S. Cl. 436/5

(57) ABSTRACT

Methods and devices for determining a quality of a substrate surface are provided. Embodiments of the subject methods include producing a plurality of droplets on the surface of a substrate, illuminating the droplet-coated surface, observing a resultant optical property from the surface; and evaluating a quality of the substrate based on the observed optical property. In certain embodiments, an evaluated substrate is one which is to be used in the fabrication of an array assembly and the evaluation is performed prior to fabricating an array on the subject surface. In certain embodiments, an evaluated substrate is one which includes one or more arrays thereon and the evaluation is performed subsequent to the fabrication of the array on the substrate, e.g., to evaluate the quality of the features of the fabricated array. Also provided are apparatuses, systems and kits for use in practicing the subject methods.

### BACKGROUND OF THE INVENTION

Arrays of binding agents (ligands), such as nucleic acids and polypeptides, have become an increasingly important tool in the biotechnology industry and related fields. These binding agent or ligand arrays, in which a plurality of binding agents are positioned on a solid support surface in the form of an array or pattern, find use in a variety of applications, including gene expression analysis, drug screening, nucleic acid sequencing, mutation analysis, and the like.

Where the ligands of the arrays are polymeric, e.g., as is the case with nucleic acid and polypeptide arrays, there are two main ways of producing such arrays, i.e., via in-situ synthesis in which the polymeric ligand is grown on the surface of the substrate in a step-wise fashion and via deposition of the full ligand, e.g., a pre-synthesized nucleic acid/polypeptide, cDNA fragment, etc., onto the surface of the array.

Regardless of the particular method of array fabrication, an important goal is to employ processes that limit variations in the thus-fabricated product so that uniform product quality can be attained. As noted above, arrays are fabricated on substrate surfaces. Subtle to obvious differences in the chemical and/or physical uniformity of the substrate surface upon which an array may be fabricated and/or in the uniformity of the fabricated array features themselves could greatly impact the results obtained from the use of a fabricated array on the substrate. For example, subtle differences in the surface properties of the substrate may affect downstream processes, including further fabrication processes and array assay processes.

Accordingly, there continues to be an interest in the development of methods and devices capable of determining a quality of a substrate surface. Of particular interest are such methods and devices that are cost effective and which do not destroy the evaluated substrate.

### SUMMARY OF THE INVENTION

Methods and devices for determining a quality of a substrate surface are provided. Embodiments of the subject methods include producing a plurality of droplets on the surface of a substrate, illuminating the droplet-coated surface, observing a resultant optical property from the surface; and evaluating a quality of the substrate based on the observed optical property. In certain embodiments, an evaluated substrate is one which is to be used in the fabrication of an array assembly and the evaluation is performed prior to fabricating an array on the subject surface. In certain embodiments, an evaluated substrate is one which includes one or more arrays thereon and the evaluation is performed subsequent to the fabrication of the array on the substrate, e.g., to evaluate the quality of the features of the fabricated array. Also provided are apparatuses, systems and kits for use in practicing the subject methods.

### BRIEF DESCRIPTION OF THE DRAWINGS

FIG. 1 shows an exemplary embodiment of a device that may be employed in the practice of the subject invention;

FIG. 2 shows a cross-sectional view of the substrate of FIG. 1 having a droplet on a surface thereof, wherein the droplet-coated surface of the substrate is illuminated;

FIG. 3 shows the contact angle of the droplet and the substrate of FIG. 2;

FIGS. 4A and 4B show various optical properties of an illuminated droplet wherein FIG. 4A shows refraction through a droplet with low contact angles and FIG. 4B shows surface reflections from a droplet with low contact angles;

FIGS. 5A and 5B show various optical properties of an illuminated droplet wherein FIG. 5A shows internal reflection from a droplet with high contact angles and FIG. 5B shows surface reflections from a droplet with high contact angles;

FIG. 6 shows an exemplary embodiment of an apparatus that may be employed in the practice of the subject invention;

FIG. 7 shows another exemplary embodiment of a peltier apparatus that may be employed in the practice of the subject invention;

FIG. 8 shows an image obtained from an illuminated, droplet-covered substrate wherein areas of relative light are observed, indicating contamination on the substrate;

FIG. 9 shows an image obtained from an illuminated, droplet-covered silylated substrate wherein areas of relative light are observed, indicating non-uniformity of the silylated coating on the substrate;

FIG. 10 shows an image obtained from an illuminated, droplet-covered substrate having deprotected, unhybridized features thereon, wherein areas of relative light are observed, indicating non-uniformity of the array features;

FIG. 11 shows an image obtained from an illuminated, droplet-covered substrate having unhybridized features thereon, wherein areas of relative light are observed, indicating non-uniformity of the array features. The single droplet covering each feature exhibits a high contrast ring that may be used to evaluate feature uniformity;

FIG. 12 shows an exemplary substrate carrying an array;

FIG. 13 shows an enlarged view of a portion of FIG. 11 showing spots or features; and

FIG. 14 is an enlarged view of a portion of the substrate of FIG. 13.

### DEFINITIONS

A “biopolymer” is a polymer of one or more types of repeating units. Biopolymers are typically found in biological systems and include, but are not limited to, polysaccharides (such as carbohydrates), and peptides (which term is used to include polypeptides, and proteins whether or not attached to a polysaccharide) and polynucleotides as well as their analogs, such as those compounds composed of or containing amino acid analogs or non-amino acid groups, or nucleotide analogs or non-nucleotide groups. This includes polynucleotides in which the conventional backbone has been replaced with a non-naturally occurring or synthetic backbone, and nucleic acids (or synthetic or naturally occurring analogs) in which one or more of the conventional bases has been replaced with a group (natural or synthetic) capable of participating in Watson-Crick type hydrogen bonding interactions or Wobble interactions. Polynucleotides include single or multiple stranded configurations, where one or more of the strands may or may not be completely aligned with another. A “nucleotide” refers to a sub-unit of a nucleic acid and has a phosphate group, a 5 carbon sugar and a nitrogen containing base, as well as functional analogs (whether synthetic or naturally occurring) of such sub-units which in the polymer form (as a polynucleotide) can hybridize with naturally occurring polynucleotides in a sequence specific manner analogous to that of two naturally occurring polynucleotides. For example, a “biopolymer” includes DNA (including cDNA), RNA, oligonucleotides, and PNA and other polynucleotides as described in U.S. Pat. No. 5,948,902 and references cited therein (all of which are incorporated herein by reference), regardless of the source. An “oligonucleotide” generally refers to a nucleotide multimer of about 10 to 100 nucleotides in length, while a “polynucleotide” includes a nucleotide multimer having any number of nucleotides.

A “biomonomer” references a single unit, which can be linked with the same or other biomonomers to form a biopolymer (for example, a single amino acid or nucleotide with two linking groups one or both of which may have removable protecting groups). A biomonomer fluid or biopolymer fluid reference a liquid containing either a biomonomer or biopolymer, respectively (typically in solution).

An “array”, unless a contrary intention appears, includes any one, two or three-dimensional arrangement of addressable regions bearing a particular chemical moiety or moieties (for example, biopolymers such as polynucleotide sequences) associated with that region. Each region may extend into a third dimension in the case where the substrate is porous while not having any substantial third dimension measurement (thickness) in the case where the substrate is non-porous. An array is “addressable” in that it has multiple regions of different moieties (for example, different polynucleotide sequences) such that a region (a “feature” or “spot” of the array) at a particular predetermined location (an “address”) on the array will detect a particular target or class of targets (although a feature may incidentally detect non-targets of that feature). Any given substrate may carry one, two, four or more arrays disposed on a front surface of the substrate. Depending upon the use, any or all of the arrays may be the same or different from one another and each may contain multiple spots or features.

An array may contain one or more, including more than two, more than ten, more than one hundred, more than one thousand, more ten thousand features, or even more than one hundred thousand features, in an area of less than 20 cm² or even less than 10 cm², e.g., less than about 5 cm², including less than about 1 cm², less than about 1 mm², e.g., 100 μ², or even smaller. By “feature” or “spot”, used interchangeably, is meant a polymer, i.e., binding agent, present as a composition of multiple copies of the polymer on an array substrate surface. The multiple copies may be in any shape, including round and non-round shapes.

For example, features may have widths (that is, diameter, for a round spot) in the range from about 10 μm to about 1.0 cm. In other embodiments each feature may have a width in the range of about 1.0 μm to about 1.0 mm, usually about 5.0 μm to about 500 μm, and more usually about 10 μm to about 200 μm. Non-round features may have area ranges equivalent to that of circular features with the foregoing width (diameter) ranges. At least some, or all, of the features are of different compositions (for example, when any repeats of each feature composition are excluded the remaining features may account for at least 5%, 10%, 20%, 50%, 95%, 99% or 100% of the total number of features). Inter-feature areas will typically (but not essentially) be present which do not carry any nucleic acids (or other biopolymer or chemical moiety of a type of which the features are composed). It will be appreciated though, that the inter-feature areas, when present, could be of various sizes and configurations.

Each array may cover an area of less than 200 cm², or even less than 50 cm², 5 cm², 1 cm², 0.5 cm², or 0.1 cm². In certain embodiments, the substrate carrying the one or more arrays will be shaped generally as a rectangular solid (although other shapes are possible), having a length of more than 4 mm and less than 150 mm, usually more than 4 mm and less than 80 mm, more usually less than 20 mm; a width of more than 4 mm and less than 150 mm, usually less than 80 mm and more usually less than 20 mm; and a thickness of more than 0.01 mm and less than 5.0 mm, usually more than 0.1 mm and less than 2 mm and more usually more than 0.2 and less than 1.5 mm, such as more than about 0.8 mm and less than about 1.2 mm. With arrays that are read by detecting fluorescence, the substrate may be of a material that emits low fluorescence upon illumination with the excitation light. Additionally in this situation, the substrate may be relatively transparent to reduce the absorption of the incident illuminating laser light and subsequent heating if the focused laser beam travels too slowly over a region. For example, the substrate may transmit at least 20%, or 50% (or even at least 70%, 90%, or 95%), of the illuminating light incident on the front as may be measured across the entire integrated spectrum of such illuminating light or alternatively at 532 nm or 633 nm.

In the case of an array, the “target” will be referenced as a moiety in a mobile phase (typically fluid), to be detected by probes (“target probes”) which are bound to the substrate at the various regions. However, either of the “target” or “target probes” may be the one which is to be evaluated by the other (thus, either one could be an unknown mixture of polynucleotides to be evaluated by binding with the other).

The term “hybridization” as used herein refers to binding between complementary or partially complementary molecules, for example as between the sense and anti-sense strands of double-stranded DNA. Such binding is commonly non-covalent binding, and is specific enough that such binding may be used to differentiate between highly complementary molecules and others less complementary. Examples of highly complementary molecules include complementary oligonucleotides, DNA, RNA, and the like, which comprise a region of nucleotides arranged in the nucleotide sequence that is exactly complementary to a probe; examples of less complementary oligonucleotides include ones with nucleotide sequences comprising one or more nucleotides not in the sequence exactly complementary to a probe oligonucleotide. “Hybridizing” and “binding”, with respect to polynucleotides, are used interchangeably.

An “array assembly” may be one or more arrays plus only a substrate on which the one or more arrays are deposited, although the assembly may be in the form of a package which includes other elements (such as a housing with a chamber). Specifically, an array assembly at least includes a substrate having at least one array thereon.

When one item is indicated as being “remote” from another, this is referenced that the two items are at least in different buildings, and may be at least one mile, ten miles, or at least one hundred miles apart. “Communicating” information references transmitting the data representing that information as electrical signals over a suitable communication channel (for example, a private or public network). “Forwarding” an item refers to any means of getting that item from one location to the next, whether by physically transporting that item or otherwise (where that is possible) and includes, at least in the case of data, physically transporting a medium carrying the data or communicating the data.

A “chamber” references an enclosed volume (although a chamber may be accessible through one or more ports).

It will also be appreciated that throughout the present application, that words such as “front”, “back”, “top”, “upper”, and “lower” are used in a relative sense only.

“Fluid” is used herein to reference a liquid.

“May” refers to optionally. Any recited method can be carried out in the ordered sequence of events as recited, or any other logically possible sequence. “Optional” or “optionally” means that the subsequently described circumstance may or may not occur, so that the description includes instances where the circumstance occurs and instances where it does not.

“Continuous” in reference to an area on the substrate surface references an area which is uninterrupted by any gaps within that area. The distinct features of an array may then be formed on such a continuous area.

The terms “target” “target molecule” “target biomolecule” and “analyte” are used herein interchangeably and refer to a known or unknown molecule in or suspected of being in a sample. A target is one that will bind, e.g., hybridize, to a probe on a substrate surface if the target molecule and the molecular probe are complementary, e.g., if they contain complementary regions, i.e., if they are members of a specific binding pair.

The term “probe” as used herein refers to a molecule of known identity adherent to a substrate.

“Probe copies” refers to exact copies of a given probe.

The term “hybridization solution” or “hybridization reagent” used herein interchangeably refers to a solution suitable for use in a hybridization reaction.

A “linking layer” bound to the surface may, for example, be less than 200 angstroms or even less than 10 angstroms in thickness (or less than 8, 6, or 4 angstroms thick). Such layer may have a polynucleotide, protein, nucleoside or amino acid minimum binding affinity of 10⁴ to 10⁶ units/μ². Layer thickness may be evaluated using UV or X-ray elipsometry.

The term “stringent assay conditions” as used herein refers to conditions that are compatible to produce binding pairs of nucleic acids, e.g., surface bound and solution phase nucleic acids, of sufficient complementarity to provide for the desired level of specificity in the assay while being less compatible to the formation of binding pairs between binding members of insufficient complementarity to provide for the desired specificity. Stringent assay conditions are the summation or combination (totality) of both hybridization and wash conditions.

A “stringent hybridization” and “stringent hybridization wash conditions” in the context of nucleic acid hybridization (e.g., as in array, Southern or Northern hybridizations) are sequence dependent, and are different under different experimental parameters. Stringent hybridization conditions that can be used to identify nucleic acids within the scope of the invention can include, e.g., hybridization in a buffer comprising 50% formamide, 5×SSC, and 1% SDS at 42° C., or hybridization in a buffer comprising 5×SSC and 1% SDS at 65° C., both with a wash of 0.2×SSC and 0.1% SDS at 65° C. Exemplary stringent hybridization conditions can also include a hybridization in a buffer of 40% formamide, 1 M NaCl, and 1% SDS at 37° C., and a wash in 1×SSC at 45° C. Alternatively, hybridization to filter-bound DNA in 0.5 M NaHPO4, 7% sodium dodecyl sulfate (SDS), 1 mM EDTA at 65° C., and washing in 0.1×SSC/0.1% SDS at 68° C. can be employed. Yet additional stringent hybridization conditions include hybridization at 60° C. or higher and 3×SSC (450 mM sodium chloride/45 mM sodium citrate) or incubation at 42° C. in a solution containing 30% formamide, 1M NaCl, 0.5% sodium sarcosine, 50 mM MES, pH 6.5. Those of ordinary skill will readily recognize that alternative but comparable hybridization and wash conditions can be utilized to provide conditions of similar stringency.

In certain embodiments, the stringency of the wash conditions set forth the conditions which determine whether a nucleic acid is specifically hybridized to a surface bound nucleic acid. Wash conditions used to identify nucleic acids may include, e.g.: a salt concentration of about 0.02 molar at pH 7 and a temperature of at least about 50° C. or about 55° C. to about 60° C.; or, a salt concentration of about 0.15 M NaCl at 72° C. for about 15 minutes; or, a salt concentration of about 0.2×SSC at a temperature of at least about 50° C. or about 55° C. to about 60° C. for about 15 to about 20 minutes; or, the hybridization complex is washed twice with a solution with a salt concentration of about 2×SSC containing 0.1% SDS at room temperature for 15 minutes and then washed twice by 0.1×SSC containing 0.1% SDS at 68° C. for 15 minutes; or, equivalent conditions. Stringent conditions for washing can also be, e.g., 0.2×SSC/0.1% SDS at 42° C.

A specific example of stringent assay conditions is rotating hybridization at 65° C. in a salt based hybridization buffer with a total monovalent cation concentration of 1.5 M (e.g., as described in U.S. patent application Ser. No. 09/655,482 filed on Sep. 5, 2000, the disclosure of which is herein incorporated by reference) followed by washes of 0.5×SSC and 0.1×SSC at room temperature.

Stringent assay conditions are hybridization conditions that are at least as stringent as the above representative conditions, where a given set of conditions are considered to be at least as stringent if substantially no additional binding complexes that lack sufficient complementarity to provide for the desired specificity are produced in the given set of conditions as compared to the above specific conditions, where by “substantially no more” is meant less than about 5-fold more, typically less than about 3-fold more. Other stringent hybridization conditions are known in the art and may also be employed, as appropriate.

The term “ligand” as used herein refers to a moiety that is capable of covalently or otherwise chemically binding a compound of interest. Ligands may be naturally-occurring or manmade. Examples of ligands include, but are not restricted to, agonists and antagonists for cell membrane receptors, toxins and venoms, viral epitopes, hormones, opiates, steroids, peptides, enzyme substrates, cofactors, drugs, lectins, sugars, oligonucleotides, nucleic acids, oligosaccharides, and proteins.

The term “receptor” as used herein is a moiety that has an affinity for a ligand. Receptors may be naturally-occurring or manmade. They may be employed in their unaltered state or as aggregates with other species. Receptors may be attached, covalently or noncovalently, to a binding member, either directly or via a specific binding substance. Examples of receptors include, but are not restricted to, antibodies, cell membrane receptors, monoclonal antibodies and antisera reactive with specific antigenic determinants, viruses, cells, drugs, polynucleotides, nucleic acids, peptides, cofactors, lectins, sugars, polysaccharides, cellular membranes, and organelles. Receptors are sometimes referred to in the art as anti-ligands. As the term receptors is used herein, no difference in meaning is intended. A “Ligand Receptor Pair” is formed when two molecules have combined through molecular recognition to form a complex.

The term “sample” as used herein relates to a material or mixture of materials, typically, although not necessarily, in fluid form, containing or suspected of containing one or more components (targets) of interest.

A “computer-based system” refers to the hardware means, software means, and data storage means used to analyze the information of the present invention. The minimum hardware of computer-based systems as they relate to the present invention include a central processing unit (CPU), input means, output means, and data storage means. A skilled artisan can readily appreciate that any one of the currently available computer-based system are suitable for use in the present invention. The data storage means may include any manufacture comprising a recording of the present information as described above, or a memory access means that can access such a manufacture.

To “record” data, programming or other information on a computer readable medium refers to a process for storing information, using any such methods as known in the art. Any convenient data storage structure may be chosen, based on the means used to access the stored information. A variety of data processor programs and formats may be used for storage, e.g. word processing text file, database format, etc.

A “processor” references any hardware and/or software combination that will perform the functions required of it. For example, any processor herein may be a programmable digital microprocessor such as available in the form of an electronic controller, mainframe, server or personal computer (desktop or portable). Where the processor is programmable, suitable programming can be communicated from a remote location to the processor, or previously saved in a computer program product (such as a portable or fixed computer readable storage medium, whether magnetic, optical or solid state device based). For example, a magnetic medium or optical disk may carry the programming, and can be read by a suitable reader communicating with each processor at its corresponding station.

The term “surface energy” (measured in ergs/cm²) of a liquid or solid substance pertains to the free energy of a molecule on the surface of the substance, which is necessarily higher than the free energy of a molecule contained in the interior of the substance; surface molecules have an energy roughly about 25% above that of interior molecules. The term “surface tension” refers to the tensile force tending to draw surface molecules together, and although measured in different units (as the rate of increase of surface energy with area, in dynes/cm), is numerically equivalent to the corresponding surface energy. By modifying a substrate surface to “reduce” surface energy, is meant lowering the surface energy below that of the unmodified surface, and vice versa.

### DETAILED DESCRIPTION OF THE INVENTION

Methods and devices for determining a quality of a substrate surface are provided. Embodiments of the subject methods include producing a plurality of droplets on the surface of a substrate, illuminating the droplet-coated surface, observing a resultant optical property from the surface; and evaluating a quality of the substrate based on the observed optical property. In certain embodiments, an evaluated substrate is one which is to be used in the fabrication of an array assembly and the evaluation is performed prior to fabricating an array on the subject surface. In certain embodiments, an evaluated substrate is one which includes one or more arrays thereon and the evaluation is performed subsequent to the fabrication of the array on the substrate, e.g., to evaluate the quality of the features of the fabricated array. Also provided are apparatuses, systems and kits for use in practicing the subject methods.

Before the present invention is described, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a”, “an”, and “the” include plural referents unless the context clearly dictates otherwise.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention.

The figures shown herein are not necessarily drawn to scale, with some components and features being exaggerated for clarity.

### METHODS OF EVALUATING A QUALITY OF A SUBSTRATE SURFACE

As noted above, embodiments of the subject invention include methods for evaluating a quality of a substrate surface. A feature of the subject methods is that they are not destructive and thus the substrate is not destroyed or deteriorated or otherwise rendered unusable for its intended purpose after it has been evaluated according to the subject methods. Accordingly, an evaluated substrate may be employed in subsequent processes such as array fabrication and/or use of the array assembly in an array assay.

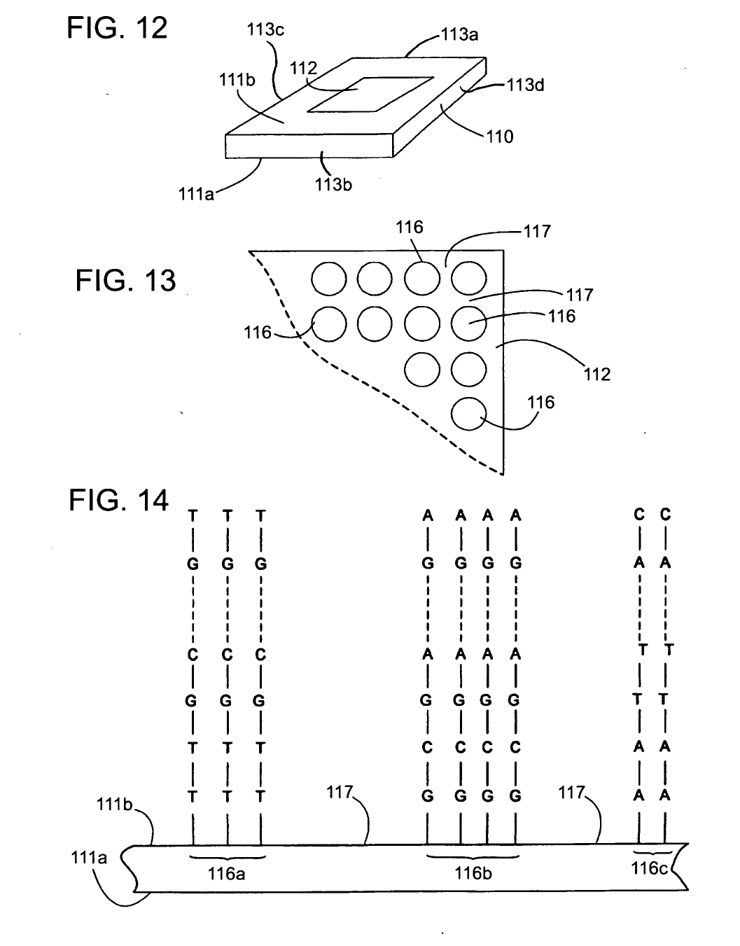

The subject methods may be used to evaluate a quality of a variety of substrates or objects. Accordingly, the material of a substrate may vary. A substrate evaluated according to the subject methods may be fabricated from a single material, or may be a composite of two or more different materials. For example, the substrates may be fabricated from a “composite,” i.e., a composition made up of different or unlike materials. The composite may be a block composite, e.g., an A-B-A block composite, an A-B-C block composite, or the like. Alternatively, the composite may be a heterogeneous combination of materials, i.e., in which the materials are distinct from separate phases, or a homogeneous combination of different or unlike materials. As used herein, the term “composite” is used to include a “laminate” composite. A “laminate” refers to a composite material formed from several different bonded layers of identical or different materials. Representative materials from which a substrate may be fabricated include, but are not limited to: plastics, such as polyacrylamide, polyacrylate, polymethacrylate, polyesters, polyolefins, polyethylene, polytetrafluoro-ethylene, polypropylene, poly (4-methylbutene), polystyrene, poly(ethylene terephthalate); fused silica (e.g., glass); bioglass; silicon chips, ceramics; metals; and the like, where in certain embodiments the substrate may be an optically transparent substrate. In certain embodiments, the substrate may be made from glass or the like. Substrates may be analogous to that described below with respect to FIGS. 12-14.

The surface of a substrate may be one that has been (or will be) treated to provide a primed or functionalized surface, that is, a surface that is able to support synthetic steps involved in the production of a chemical compound. Functionalization relates to modification of the surface of a substrate to provide a plurality of functional groups on the support surface. The term “functionalized surface” is meant a substrate surface that has been modified so that a plurality of functional groups are present thereon. The manner of treatment of the substrate surface is dependent on the nature of the chemical compound to be synthesized and on the nature of the substrate surface. In one approach a reactive hydrophilic site or reactive hydrophilic group is introduced onto the surface of the support. Such hydrophilic moieties may be used as the starting point in a synthetic organic process. Substrate surfaces may be fuctionalization with a silane mixture. Manners of functionalizing a substrate surface are described, e.g., in U.S. Pat. Nos. 6,660,338; 6,649,348; and 6,258,454, the disclosures of which are herein incorporated by reference. The surface of a substrate evaluated according to the subject methods may be one that has or will have one or more arrays immobilized thereon, as described in greater detail below.

The subject methods are not limited to any particular shape of substrate. Accordingly, the shapes of substrates may range from simple to complex. In certain embodiments, the substrates will assume a square, rectangular, oblong, elliptical, oval or circular, e.g., spherical, shape. Substrates may have other geometric shapes, or irregular or complex shapes. In certain embodiments, the substrates may be planar and in certain other embodiments the substrates have more complex configurations and shapes, e.g., may be substantially non-planar, including non-planar, and may include one or more of recessed structures, elevated structures, channels, crevices, openings or orifices, surface modifications, etc.

The substrates may be rigid or flexible. By “rigid” it is meant that the substrate cannot be substantially bent or folded without breaking. By “flexible” it is meant the substrate, if flexible, may be substantially bent or folded without breaking, tearing, ripping, etc.

The subject methods are not limited to any particular size of substrate. As such, the size of a particular substrate that may be evaluated according to the subject methods may be small and may be shaped generally as a rectangular solid (although other shapes are possible), having a length of more than about 4 mm and less than about 150 mm, e.g., more than about 4 mm and less than about 80 mm, e.g., less than about 20 mm; a width of more than about 4 mm and less than about 150 mm, e.g., less than about 80 mm, e.g., less than about 20 mm; and a thickness of more than about 0.01 mm and less than about 5.0 mm, e.g., more than about 0.1 mm and less than about 2 mm, e.g., more than about 0.2 and less than about 1.5 mm, such as more than about 0.8 mm and less than about 1.2 mm. Accordingly, the total surface area of a substrate surface evaluated in accordance with the subject invention may vary. For example, in certain embodiments the surface area evaluated according to the subject methods may range from about 5.0 mm² to about 1500 cm² or more. However, the subject methods may be employed to evaluate only a portion of a substrate surface. The above dimensions are exemplary only and are in no way intended to limit the scope of the invention.

The substrates evaluated according to the subject methods may be assemblies or subassemblies of a final product or may be a final product. In other words, the substrates may be any substrate at any stage of manufacture from prior to the start of manufacture to the use of the final product. Exemplary substrates that may be evaluated in accordance with the subject methods include, but are not limited to, biopolymeric array substrates, semiconductor substrates (silicon wafers), LCD glass plates, medical and/or dental substrates and devices, laboratory equipment, e.g., laboratory glassware such as beakers, test tubes, etc.

In certain embodiments, the subject invention is employed to evaluate a substrate surface before and/or after one or more arrays have been fabricated thereon. For example, embodiments include evaluating a quality of an array assembly surface. Such array assemblies include at least one array that includes a plurality of polymeric molecules or “probes” positioned on a substrate surface, as will be described in greater detail below. In certain embodiments, prior to fabricating an array on a surface of a substrate, the substrate surface may be evaluated according to the subject methods, e.g., to evaluate the uniformity of the substrate surface (e.g., to identify any chemical and/or physical variations of the surface, etc). The evaluated substrate surface (either further processed or not following evaluation) may then be used as a substrate in an array assembly such that array features may be positioned on the evaluated substrate surface to provide a biopolymeric array assembly that includes a substrate and at least one array thereon. In certain embodiments after fabricating one or more arrays on the substrate surface (whether the array has been previously evaluated or not), the one or more arrays may be evaluated according to the subject methods, e.g., to evaluate the uniformity of some or all of the features present on a substrate surface. The evaluated array may then be used in an array assay such as a hybridization assay and the like. An evaluated array assembly may be used in a variety of array assays, as will be described in greater detail below.

As noted above, the subject substrate evaluation methods include producing droplets on a surface of a substrate to be evaluated. Accordingly, a substrate surface is populated with a plurality of liquid droplets such as a plurality of water droplets. The sizes of the droplets of the population may vary. Generally, smaller droplets will provide better or more useful images. However, if the droplets are too small, the optical effect will not provide enough contrast to give a useful image. The optimal drop size is therefore a size that provides sufficient contrast for the optical system used to capture the image. I certain embodiments, the average diameter of the droplets may range from about 2 microns to about 500 microns or more, e.g., from about 2 to about 15 microns, e.g., from about 2 to about 10 microns. In certain embodiments in which features of an array are evaluated, the average diameter of the droplets will typically, though not always, correspond with the average diameter of the features, e.g., such that each feature of the array is covered by a respective, single droplet.

The density of droplets on a substrate surface will vary depending on a variety of factors such as the actual size of each droplet, the substrate surface employed, etc., where in certain embodiments the density of droplets may range from about 5 droplets to about 1,000 droplets or more per mm², e.g., from about 10 to about 1,000 droplets or more per mm², e.g., where the mean diameter of droplets falls within the ranges described above.

Covering the surface area to be evaluated with a plurality of droplets may be accomplished in any suitable manner, where the selection of the technique employed depends on a variety of factors, such as the material of the substrate, the choice of the liquid chosen at least in part with respect to the compatibility with the substrate, cost, and the like. For example, droplets may be sprayed onto the substrate surface, and the like. In certain embodiments, the subject methods include generating a fog on the substrate surface (“fogging the surface”). Fog generation on a substrate surface may be accomplished by employing any suitable technique. For example a fog may be produced by ultrasonically agitating a liquid, applying steam over dry ice, condensation of vapor-phase liquids on a substrate surface, technology analogous to ink-jet printing, etc., where such fog generation methods are exemplary only and are in no way intended to limit the scope of the invention.

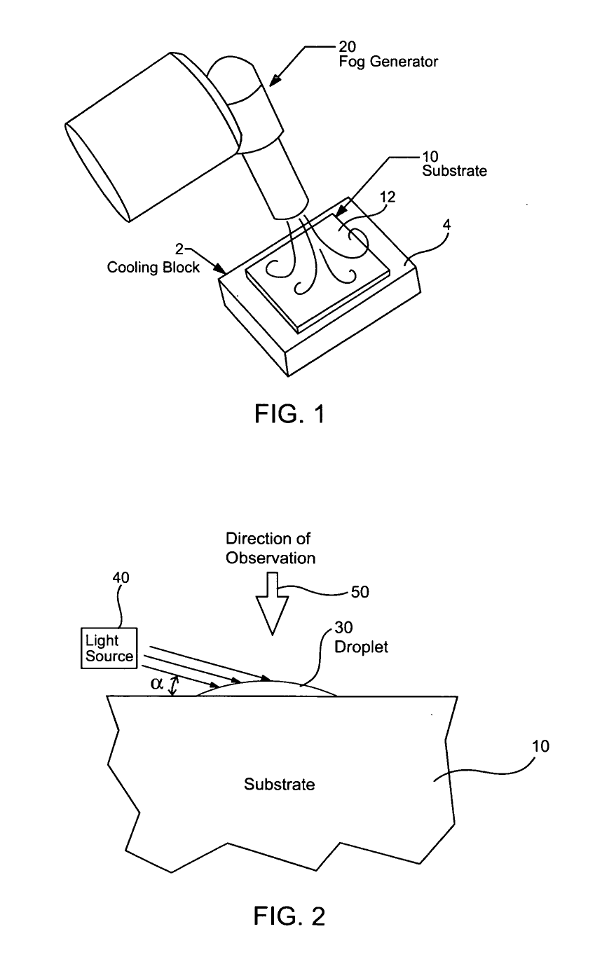

A simple and low cost method that may be used includes populating a substrate surface with a plurality of liquid droplets by condensing a liquid on a substrate surface exposed to the liquid's vapor phase. In such embodiments, the substrate surface is maintained at a temperature sufficient to condense the vapor on the substrate surface. This may be accomplished, e.g., with water vapor (e.g., vapor of pure water) or the vapor phase of any other suitable liquid, where the particular liquid chosen depends at least in part on the vaporization and condensation temperatures that are compatible with substrate, etc. FIG. 1 shows an exemplary embodiment of a device for providing a plurality of droplets on a substrate surface by condensing water vapor thereon using a device capable of generating fog. Fog generator 20 is capable of providing a plurality of droplets on the surface 12 of substrate 10 (which may be a glass substrate or the like) positioned on a surface 4 of cooling block 2 which is capable of maintaining the substrate at a suitable temperature as described above.

The liquid employed in the subject invention may be any suitable liquid. In general, the liquid employed is chosen, as noted above, at least for compatibility with the substrate and the like. That is, the liquid employed is one that does not harm or adversely affect the substrates evaluated.

A variety of liquids or combinations of liquids may be employed in the subject invention, where such liquids include aqueous and non-aqueous liquids. The liquid employed may have any suitable pH, where the pH may vary depending on a variety of factors. For example, the pH of the liquid is compatible with the particular substrate surface being evaluated. In certain embodiments, the pH may range from about 5 to about 12, e.g., from around about 7 in certain embodiments.

A variety of liquids may be used in the practice of the subject methods. For example, in those embodiments in which a fog is provided on a substrate surface by introducing a liquid in the vapor phase and condensing it on a cooler surface, then the liquid solution used is one which is compatible with this process. In many embodiments, the liquid used is one that is substantially free, including completely free, of dissolved solids. Liquids that may be employed in the subject invention include, but are not limited to, aqueous, semi-aqueous and non-aqueous fluids, including organic and inorganic fluids, e.g., suitable solvents and the like (e.g., synthetic solvents, organic solvents, etc.). Representative fluids include, but are not limited to, water (tap or pure water (or substantially pure water), e.g., deionized (d.i.) water, distilled water, etc.,), alcohols, chlorinated water, etc. For example, suitable liquids include, but are not limited to, water such as pure water, water with calcium chloride (various concentrations up to saturated), water with lithium chloride (various concentrations up to saturated), water with ethanol, and the like. Accordingly, in certain embodiments of the subject invention the liquid is pure water or pure water and a buffering system, thus providing an effective substrate evaluation liquid that is easy to prepare and is safe for human contact and environmental disposal. Of interest is deionized water in many embodiments. In those embodiments in which solutions of water that has dissolved solids in it is used and the droplets are provided on a substrate surface by creating the small droplets with ultrasound or the like, a step of rinsing the droplets off (e.g., with pure water and the like) after evaluating a quality of the substrate surface may be included in the subject methods to remove any solids left on the substrate surface. The liquids described above are exemplary only and are in no way intended to limit the scope of the invention as other suitable liquids may be employed. In certain embodiments two or more different liquids may be employed.

The liquids employed in the subject invention may or may not include additional components, e.g., buffers, emulsifiers, dispersants, surfactants (anionic, nonionic, cationic, amphoteric), wetting agents, saponifiers, builders, alkaline salts, chelating agents, sequestering agents, etc. Many embodiments may employ a chemical buffer to prevent the pH from changing significantly from a desired pH, e.g., due to exposure to the air.

Once a plurality of droplets are produced on a substrate surface, the droplet coated surface is illuminated. Accordingly, one or more light sources direct light at the droplet coated substrate surface, as shown in FIG. 2 which provides a cross sectional view of the substrate of FIG. 1 showing a droplet 30 on the surface of the substrate. Light source 40 illuminates the droplet-coated surface of the substrate with light. The light may be of any suitable wavelength and may depend on, e.g., the substrate, the liquid droplet, etc. In certain embodiments the visible light may be used and in certain embodiments ultraviolet light may be used. In certain embodiments, the wavelengths may range from about 10 nm to about 10,000 nm, e.g., from about 30 nm to about 720 nm, e.g., from about 380 nm to about 720 nm. For example, where droplet 30 is a water droplet, the water droplet may be illuminated with light of a wavelength of about 100 nm. In certain embodiments, the light source(s) illuminate a surface from an oblique angle. For example, the angle of incidence α that a light ray makes with the normal to the droplet coated surface on which it is incident may range from about 0° to about 90°, e.g., from about 1° to about 90°, e.g., from about 60° to about 87°. The number of light sources employed to illuminate a substrate surface, e.g., from oblique angles, may range from about 1 to about hundreds or even thousands, e.g., as in the case of fiber-optic bundles and LED (light emitting diode) arrays. In many embodiments at least two illumination sources are employed, e.g., at two different substrate edges. While uniform illumination of a substrate surface may be employed in many embodiments, software filtering may be employed to compensate for non-uniformity of illumination.

Once illuminated, the resultant optical properties from the substrate surface are observed to evaluate a quality of the substrate. For example, the optical properties may be related to uniformity on the substrate surface. By “optical property” is meant broadly to include an observation of how a material (droplet) reacts to exposure to light. When light strikes an object it may be transmitted, absorbed, or reflected and as such the subject methods include observing one or more aspects related to the transmission and/or absorption and/or reflection of light from a droplet-coated surface. Accordingly, in certain embodiments a droplet-coated substrate surface is illuminated with light and at least one of refracted light, reflected light and the diffusion of light is observed from the substrate surface. Observing resultant optical properties from an illuminated, droplet-coated substrate surface provides valuable information about variations of the substrate surface.

A variety of different qualities may be evaluated by observing resultant optical properties from an illuminated, droplet-coated substrate surface. Embodiments include evaluating a substrate with respect to manufacturing processes, suitability for intended use, and the like. For example, a quality evaluated may include evaluating physical aspects of a substrate surface, e.g., for physical defects such as unwanted grooves, bumps, etc., contamination of a substrate (cleanliness), chemical aspects of a substrate such as functionality of the substrate surface, array features, and the like.

In certain embodiments, the subject methods may be employed to evaluate the uniformity of the substrate surface. Uniformity may be with respect to a variety of different aspects of the substrate, such as contaminating substances, non-uniformity of surface chemistry, direction of polymerization, and the like. Accordingly, uniformity/non-uniformity may be artifacts of particular manufacturing problems such as non-uniformity of a process within a batch, variations produced by handling or storage, etc. Terms such as contaminating substances, adherent residues, and the like are used herein broadly to describe a substance present on a substrate surface, regardless or its origin and make-up, in need of removal (i.e., an unwanted substance), where such terms are not intended to be limiting in any manner. Contaminants may include, but are not limited to, debris from a laser processing step (e.g., from laser-scribing glass and the like), films, oils, greases, waxes, dust, oxides, fingerprints including latex glove prints and the like, tarnish, rust, dried blood, residual substances left by manufacturing equipments such as by a vacuum gripper and the like, as well as many other organic and inorganic residues, substances and contaminants. Contaminants may be ones that are unintentionally deposited on a substrate surface or may be a byproduct of a prior procedure or may be ones that are intentionally deposited on a substrate surface, e.g., may be useful for a certain procedure such as chemical modification and the like, but which may ultimately be in need of removal or at least be known, e.g., prior to a subsequent procedure and/or use of the final product. It will be apparent that the subject methods may be employed with a substrate that does not have a contaminant or other non-uniformity on a surface thereof. That is, a substrate surface employed in the subject methods may or may not actually have a contaminant or non-uniformity thereon such that the substrate surface may be one that is suspected of being contaminated or non-uniform in one or more respects.

Variations in observed optical properties from a substrate surface relate to the form and shape of the droplets on the substrate surface, which are influenced by variations of the substrate surface. Accordingly, embodiments of the subject invention uses variations in observed light (e.g., areas of relative lightness and darkness) from the substrate surface to indicate non-uniformity of the substrate surface.

Embodiments of the subject invention use non-uniformity of surface energy on a substrate surface as a marker for, or indicator of, variations in other surface properties such as physical and/or chemical differences. Furthermore, surface energy can itself be a factor in reactions on the substrate surface, e.g., catalytic reactions and reaction rates. In certain embodiments, evaluation of non-uniformity of surface energy on a substrate surface includes directly or indirectly observing contact angles between the droplets and the substrate surface, where the determined contact angles are a function of the form and shape of the droplets and thus are indicative of the uniformity of the substrate, as noted above. For example, the relative differences in light from the substrate surface, which is related to contact angles, and thus various surface energies, may be observed and/or measurements of contact angles may be made. The differences of relative light may be observed qualitatively (e.g., by visual observation) or quantitatively (e.g., by determining units of luminosity, etc.).

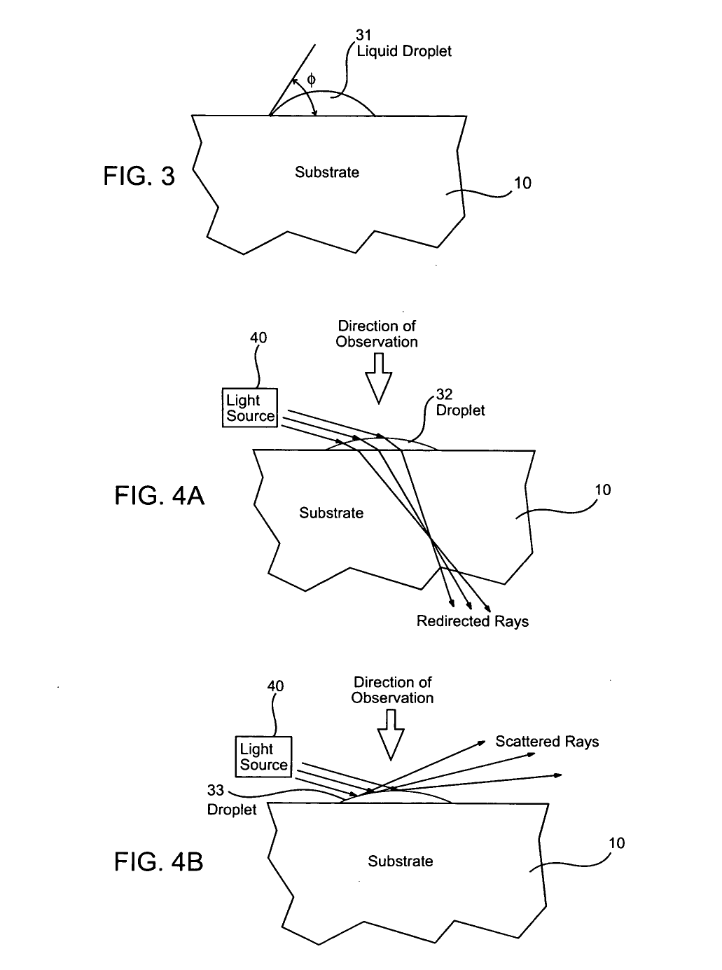

The surface energy of the substrate affects the wetting ability of the surface. While not being tied to any particular theory, by way of background the wetting ability is an interaction of the surface energies of the solid-liquid interface, the solid-gas interface and the liquid-gas interface. The cohesions forces between the molecules of the liquid cause surface extensions. When liquid comes in contact with the surface of a solid, the adhesive forces between the liquid and the solid's surface compete against the cohesive forces in the liquid. If the adhesive forces are stronger than the cohesive forces in the liquid, the liquid spreads or “wets” the surface. If, however, the liquid molecules are more strongly attracted to each other than they are to the surface, the liquid tends to “bead up” and does not wet the surface as well. One way to evaluate wetting ability and thus the surface energy of a particular area of a substrate is to observe the contact angle θ with respect to a droplet of liquid present on a substrate surface, as shown in FIG. 3. The variation in contact angles is a product of variation in surface energies, wherein variation in surface energies (or other analogous feature) may be related to non-uniformity, i.e., non-homogeneity, of the substrate surface. These variations may be detected by observing the pattern of light from the substrate surface. For example, non-uniformity may be observed as variations in the light (areas of relative brightness/darkness) from the substrate surface.

Small differences in properties of substrates, i.e., non-uniformity for whatever the cause, can dramatically change the pattern of surface energy across a substrate surface, thus resulting in non-uniformity of surface energy. The contact angles between the substrate surface and the droplets are influenced by the surface energy of the substrate surface such that areas having relatively higher surface energies will produce droplets that spread out (are relatively flattened) on the surface to a greater extent that droplets positioned on areas of the substrate having relatively low surface energies, where low surface energy areas will compete less with the cohesions within the droplet producing relatively spherical droplets. When a droplet coated surface is illuminated, the droplets function as optical elements and redirect the light by a combination of refraction, reflection and diffusion. The relative influence of these optical effects provides patterns of relative light and dark areas on the substrate surface, indicating the degree of uniformity of the illuminated surface.

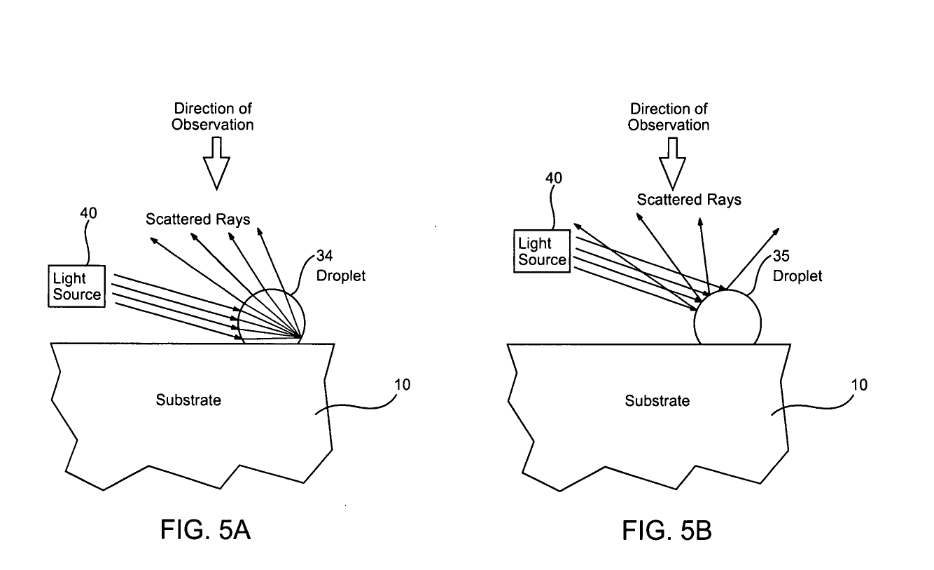

Areas on a surface where the surface energies are high, and thus relative contact angles are low, will produce droplets that act like thin lenses with long focal lengths, refracting light source rays away from the point of observation and the areas will appear dark, as shown in FIGS. 4A and 4B, wherein FIG. 4A shows refraction through a droplet 32 with low contact angles and FIG. 4B shows surface reflections from a droplet 33 with low contact angles. Areas on the surface where the surface energies are low, and thus relative contact angles are high, will scatter more light back to the observation point, thus appearing brighter as shown in FIGS. 5A and 5B, wherein FIG. 5A shows internal reflection from a droplet 34 with high contact angles and FIG. 5B shows surface reflections from a droplet 35 with high contact angles. These patterns of reflection and refraction are exemplary only and it will be apparent that a number of different patterns may be observed., For example, more complex patterns of reflection and refraction that may be observed from illuminating a substrate surface with light may include multiple reflections through droplets and off of the first and second surfaces of the substrate (the first surface of the glass being the side facing the light source and the second surface being the side opposite the first surface). These more complex patterns produce the same results as described above such that droplets with high contact angles scatter more light and vice versa.

Accordingly, observing areas of non-uniformity of surface energy on a substrate surface may be accomplished by illuminating the droplet coated surface with light and observing qualitatively and/or quantitatively the amount of light obtained at an observation point, where any non-uniformity of surface energy may be used as an indication of (i.e., related to) surface variations from handling, storage, manufacturing processes, etc. Accordingly, optical properties may be observed using any suitable technique, including qualitatively and quantitatively. For example, the amount of light received at an observation point may be observed visually and/or the magnitude thereof quantified, e.g., as units of luminosity or the like. In certain embodiments, a microscope having a suitable lens may be used to visually observe the relative areas of light variations of the substrate surface. In certain embodiments, a camera having a suitable lens may be used to capture a digital image of the variations in the light. For example, a camera may include a self-calibrating 12:1 programmable zoom lens (which may or may not include optional attachment lenses such as 0.5×, 1.5×, 2.0×, and the like). Any suitable microscope, camera or analogous recording device may be employed, e.g., a color CCD camera with 768×494 array, a grayscale CCD with 768×494 array, or the like. Thus a high resolution digital image may be produced that shows any non-uniformity, if present, where, e.g., surface energy varies. In certain embodiments, commercially available video systems microscope systems may be adapted for use with the subject methods, e.g., SmartScope® video measuring systems available from Optical Gaging Products, Inc., and the like. In certain embodiments, the average and standard deviation of the luminosity of the image may be determined and the standard deviation of luminosity may be used as a measure of uniformity of the substrate.

In certain embodiments, an image may be enhanced to optimize the image. This may be accomplished in a number of different ways that will be apparent to those of skill in the art. For example, image enhancement may be accomplished by optimizing exposure times (increasing or decreasing exposure times) depending on the particular image and imaging conditions. For example, where minimal light is entering the optical property observing device (e.g., a camera or the like), exposure times may be increased to optimize the obtained image and vice versa. In certain embodiments, exposure times may range from about 1/4000 of a second to about 30 seconds or more, e.g., from about 1/4000 of a second to about 10 seconds. A digital image may be enhanced using software capable of image enhancement, e.g., to optimize brightness, contrast, etc., of an image. For example, variations of a substrate surface may be made visible using image enhancement software that may not be visible without the software enhancement-even if exposure times are optimized. Imaging enhancement software is commercially available (e.g., Photoshop Elements available from Adobe Systems, Inc.) and one of skill in the art may readily adapt such software for use in the subject methods without undue experimentation. In certain embodiments, optimizing exposure times and/or image enhancement software may be employed to increase the sensitivity of the subject evaluation methods to subtle substrate variations where necessary.

As noted above, while uniform illumination of a substrate surface may be employed in many embodiments, software filtering may be employed to compensate for non-uniformity of illumination. For example, a data file mapping the light variation over a uniform surface may be used to normalize a substrate's image made under the same lighting conditions.

One manner for determining variations of a substrate surface may include obtaining an image and determining an overall average and standard deviation of the luminosity of the image. The standard deviation of luminosity may be used as a measure of uniformity of the substrate.

Once a quality of a substrate surface is evaluated, e.g., uniformity of surface energies, the substrate surface may be modified and/or used in an array assay (if the evaluated substrate already includes one or more arrays). For example, if the substrate is a substrate to be used in the fabrication of an array assembly and the evaluation of the substrate is performed prior to fabricating one or more arrays on a surface of the substrate, the substrate may be further modified, e.g., cleaned or de-contaminated, functionalized (if not functionalized prior to evaluation), etc., and one or more arrays may be fabricated thereon.

Accordingly, evaluated substrates may be used as substrates for array assemblies that include the evaluated substrate and one or more arrays produced thereon. Arrays may be produced on an evaluated substrate using any convenient protocol. Various methods for forming arrays from preformed probes, or methods for generating the array using synthesis techniques to produce the probes in situ, including known light directed synthesis processes, are generally known in the art (see, for example, U.S. Pat. Nos. 6,180,351; 6,242,266; 6,306,599 and 6,420,180, the disclosures of which are incorporated herein by reference). For example, probes can either be synthesized directly on the solid support or substrate or attached to the substrate after they are made. Arrays may be fabricated using drop deposition from pulse jets of either polynucleotide precursor units (such as monomers) in the case of in situ fabrication, or the previously obtained polynucleotide. Other drop deposition methods may be used for fabrication. Also, instead of drop deposition methods, photolithographic array fabrication methods may be used. As mentioned above, interfeature areas need not be present, particularly when the arrays are made by photolithographic methods as described in those patents. Accordingly, as described above, the probes may be synthesized directly on a substrate, or pre-made probes may be attached to the substrate, after the substrate has been modified according to the subject invention.

Immobilization of the probe to a suitable substrate may be performed using conventional techniques. See, e.g., Letsinger et al. (1975) Nucl. Acids Res. 2:773-786 Pease A. C. et al., Proc. Nat. Acad. Sci. USA, 1994, 91:5022-5026, and Oligonucleotide Synthesis, a Practical Approach,” Gait, M. J. (ed.), Oxford, England: IRL Press (1984). The surface of a substrate may be treated with an organosilane coupling agent to functionalized the surface. See, e.g., Arkins, A Silane Coupling Agent Chemistry,” Petrarch Systems Register and Review, Eds. Anderson et al. (1987) and U.S. Pat. No. 6,258,454.

Any given substrate may carry one, two, four or more arrays disposed on a surface of the substrate. Depending upon the use, any or all of the arrays may be the same or different from one another and each may contain multiple spots or features. For example, a plurality of arrays may be stably associated with one substrate, where the arrays are spatially separated from some or all of the other arrays associated with the substrate.

An array may contain one or more, including more than two, more than ten, more than one hundred, more than one thousand, more ten thousand features, or even more than one hundred thousand features, in an area of less than 20 cm² or even less than 10 cm², e.g., less than about 5 cm², including less than about 1 cm², less than about 1 mm², e.g., 100 μ², or even smaller. By “feature” or “spot”, used interchangeably, is meant a polymer, i.e., binding agent, present as a composition of multiple copies of the polymer on an array substrate surface. The multiple copies may be in any shape, including round and non-round shapes.

For example, features may have widths (that is, diameter, for a round spot) in the range from about 10 μm to about 1.0 cm. In other embodiments each feature may have a width in the range of about 1.0 μm to about 1.0 mm, usually about 5.0 μm to about 500 μm, and more usually about 10 μm to about 200 μm. Non-round features may have area ranges equivalent to that of circular features with the foregoing width (diameter) ranges. In those embodiments in which the subject methods are employed to evaluate an array, in certain embodiments the array may be evaluated in a manner whereby each feature of the array is covered by a respective, single droplet. In such embodiments, the sizes (e.g., width or the like) of the droplets typically correspond to the sizes (e.g., width or the like) of the sizes of the features.

At least some, or all, of the features are of different compositions (for example, when any repeats of each feature composition are excluded the remaining features may account for at least 5%, 10%, 20%, 50%, 95%, 99% or 100% of the total number of features). Inter-feature areas will typically (but not essentially) be present which do not carry any nucleic acids (or other biopolymer or chemical moiety of a type of which the features are composed). It will be appreciated though, that the inter-feature areas, when present, could be of various sizes and configurations. Each array may cover an area of less than 200 cm², or even less than 50 cm², 5 cm², 1 cm², 0.5 cm², or 0.1 cm².

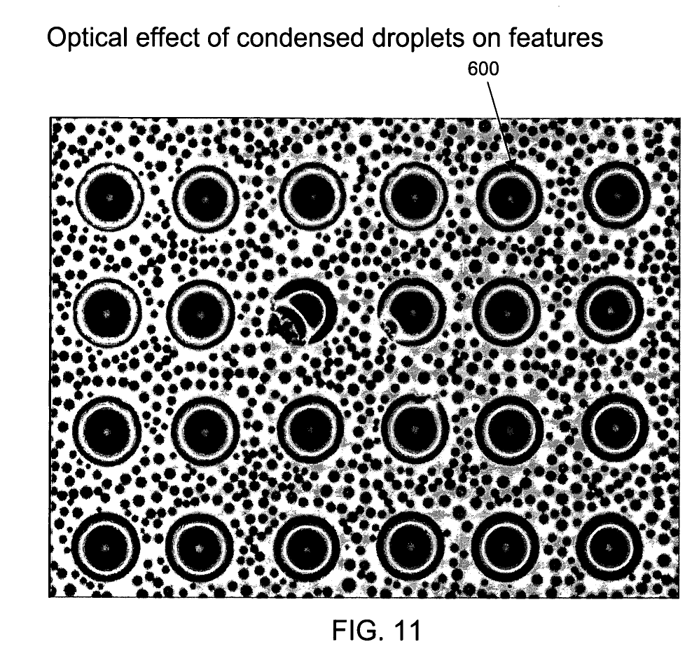

FIGS. 12-14 show an exemplary embodiment of an array where FIG. 12 shows an exemplary substrate carrying an array; FIG. 13 shows an enlarged view of a portion of FIG. 11 showing spots or features; and FIG. 14 is an enlarged view of a portion of the substrate of FIG. 13. The substrate and/or array may be an evaluate substrate and/or evaluated array. Typically biopolymeric arrays of the present invention use a contiguous planar substrate 110 carrying an array 112 disposed on a rear surface 111b of substrate 110. It will be appreciated though, that more than one array (any of which are the same or different) may be present on rear surface 111b, with or without spacing between such arrays. That is, any given substrate may carry one, two, four or more arrays disposed on a front surface of the substrate and depending on the use of the array, any or all of the arrays may be the same or different from one another and each may contain multiple spots or features. The one or more arrays 112 usually cover only a portion of the rear surface 111b, with regions of the rear surface 111b adjacent the opposed sides 113c, 113d and leading end 113a and trailing end 113b of slide 110, not being covered by any array 112. A front surface 111a of the slide 110 does not carry any arrays 112. Each array 112 may be designed for testing against any type of sample, whether a trial sample, reference sample, a combination of them, or a known mixture of biopolymers such as polynucleotides. Substrate 110 may be of any shape, as mentioned above.

As noted above, array 112 contains multiple spots or features 116 of biopolymers, e.g., in the form of polynucleotides and all of the features 116 may be different, or some or all could be the same. The interfeature areas 117 could be of various sizes and configurations. Each feature carries a predetermined biopolymer such as a predetermined polynucleotide (which includes the possibility of mixtures of polynucleotides). It will be understood that there may be a linker molecule (not shown) of any known types between the rear surface 111b and the first nucleotide.

Substrate 110 may carry on front surface 111a, an identification code, e.g., in the form of bar code (not shown) or the like printed on a substrate in the form of a paper label attached by adhesive or any convenient means. The identification code contains information relating to array 112, where such information may include, but is not limited to, an identification of array 112, i.e., layout information relating to the array(s), etc.

Once one or more arrays have been fabricated on a surface of an evaluated substrate, the resultant array assembly may be used in an array assay, as described in greater detail below.

As noted above, in certain embodiments the subject methods are employed to evaluate a substrate already having at least one array on a surface thereon, i.e., to evaluate a quality of an array assembly wherein the subject methods are performed subsequent to fabricating one or more arrays on a substrate surface. In such embodiments, the subject methods may be employed to evaluate feature uniformity. Current protocols require that the array be used in an array assay such as a hybridization assay or the like to assess array feature uniformity and thus are destructive tests. However, unlike these current protocols, the subject methods may be employed to evaluate feature uniformity without using the array in an array assay and thus provides non-destructive methods for assessing array feature uniformity, which arrays may then be used in an array assay.

The above methods may be substantially, if not completely automated, so that droplets may be produced on a substrate surface, the surface illuminated, and an image of the resultant illuminated substrate surface may be observed and recorded if desired. As such, the subject methods are amenable to high throughput applications, e.g., high throughput manufacturing applications. In automated versions of the subject methods, automated apparatuses may be employed that include at least a manner for precisely controlling the position of a droplet producing element and/or an element for observing the optical properties of from the substrate surface with respect to a substrate surface (an XYZ translational mechanism). When the present application recites “positioning”, “moving”, or analogous term, one element in relation to another element it will be understood that any required moving can be accomplished by moving either element or a combination of both of them, either manually or automatically.

Array Assays

As noted above, embodiments include using substrates evaluated according to the subject methods, and which include one or more arrays thereon, in an array assay. The arrays find use in a variety of different applications, where such applications are generally analyte detection applications in which the presence of a particular analyte (i.e., target) in a given sample is detected at least qualitatively, if not quantitatively. Protocols for carrying out such assays are well known to those of skill in the art and need not be described in great detail here. Generally, the sample suspected of containing the analyte of interest is contacted with an array produced according to the subject methods under conditions sufficient for the analyte to bind to its respective binding pair member (i.e., probe) that is present on the array. Thus, if the analyte of interest is present in the sample, it binds to the array at the site of its complementary binding member and a complex is formed on the array surface. The presence of this binding complex on the array surface is then detected, e.g. through use of a signal production system, e.g. an isotopic or fluorescent label present on the analyte, etc. The presence of the analyte in the sample is then deduced from the detection of binding complexes on the substrate surface. Specific analyte detection applications of interest include, but are not limited to, hybridization assays in which nucleic acid arrays are employed.

In these assays, a sample to be contacted with an array may first be prepared, where preparation may include labeling of the targets with a detectable label, e.g. a member of signal producing system. Generally, such detectable labels include, but are not limited to, radioactive isotopes, fluorescers, chemiluminescers, enzymes, enzyme substrates, enzyme cofactors, enzyme inhibitors, dyes, metal ions, metal sols, ligands (e.g., biotin or haptens) and the like. Thus, at some time prior to the detection step, described below, any target analyte present in the initial sample contacted with the array may be labeled with a detectable label. Labeling can occur either prior to or following contact with the array. In other words, the analyte, e.g., nucleic acids, present in the fluid sample contacted with the array may be labeled prior to or after contact, e.g., hybridization, with the array. In some embodiments of the subject methods, the sample analytes e.g., nucleic acids, are directly labeled with a detectable label, wherein the label may be covalently or non-covalently attached to the nucleic acids of the sample. For example, in the case of nucleic acids, the nucleic acids, including the target nucleotide sequence, may be labeled with biotin, exposed to hybridization conditions, wherein the labeled target nucleotide sequence binds to an avidin-label or an avidin-generating species. In an alternative embodiment, the target analyte such as the target nucleotide sequence is indirectly labeled with a detectable label, wherein the label may be covalently or non-covalently attached to the target nucleotide sequence. For example, the label may be non-covalently attached to a linker group, which in turn is (i) covalently attached to the target nucleotide sequence, or (ii) comprises a sequence which is complementary to the target nucleotide sequence. In another example, the probes may be extended, after hybridization, using chain-extension technology or sandwich-assay technology to generate a detectable signal (see, e.g., U.S. Pat. No. 5,200,314).

In certain embodiments, the label is a fluorescent compound, i.e., capable of emitting radiation (visible or invisible) upon stimulation by radiation of a wavelength different from that of the emitted radiation, or through other manners of excitation, e.g. chemical or non-radiative energy transfer. The label may be a fluorescent dye. Usually, a target with a fluorescent label includes a fluorescent group covalently attached to a nucleic acid molecule capable of binding specifically to the complementary probe nucleotide sequence.

Following sample preparation (labeling, pre-amplification, etc.), the sample may be introduced to the array using any convenient protocol, e.g., sample may be introduced using a pipette, syringe or any other suitable introduction protocol. The sample is contacted with the array under appropriate conditions to form binding complexes on the surface of the substrate by the interaction of the surface-bound probe molecule and the complementary target molecule in the sample. The presence of target/probe complexes, e.g., hybridized complexes, may then be detected. In the case of hybridization assays, the sample is typically contacted with an array under stringent hybridization conditions, whereby complexes are formed between target nucleic acids that agent are complementary to probe sequences attached to the array surface, i.e., duplex nucleic acids are formed on the surface of the substrate by the interaction of the probe nucleic acid and its complement target nucleic acid present in the sample. A “stringent hybridization” and “stringent hybridization wash conditions” in the context of nucleic acid hybridization (e.g., as in array, Southern or Northern-hybridizations) are sequence dependent, and are different under different experimental parameters. Stringent hybridization conditions that can be used to identify nucleic acids within the scope of the invention can include, e.g., hybridization in a buffer comprising 50% formamide, 5×SSC, and 1% SDS at 42° C., or hybridization in a buffer comprising 5×SSC and 1% SDS at 65° C., both with a wash of 0.2×SSC and 0.1% SDS at 65° C. Exemplary stringent hybridization conditions can also include a hybridization in a buffer of 40% formamide, 1 M NaCl, and 1% SDS at 37° C., and a wash in 1×SSC at 45° C. Alternatively, hybridization to filter-bound DNA in 0.5 M NaHPO4, 7% sodium dodecyl sulfate (SDS), 1 mM EDTA at 65° C., and washing in 0.1×SSC/0.1% SDS at 68° C. can be employed. Yet additional stringent hybridization conditions include hybridization at 60° C. or higher and 3×SSC (450 mM sodium chloride/45 mM sodium citrate) or incubation at 42° C. in a solution containing 30% formamide, 1M NaCl, 0.5% sodium sarcosine, 50 mM MES, pH 6.5. Those of ordinary skill will readily recognize that alternative but comparable hybridization and wash conditions can be utilized to provide conditions of similar stringency.

In certain embodiments, the stringency of the wash conditions that set forth the conditions which determine whether a nucleic acid is specifically hybridized to a surface bound nucleic acid. Wash conditions used to identify nucleic acids may include, e.g.: a salt concentration of about 0.02 molar at pH 7 and a temperature of at least about 50° C. or about 55° C. to about 60° C.; or, a salt concentration of about 0.15 M NaCl at 72° C. for about 15 minutes; or, a salt concentration of about 0.2×SSC at a temperature of at least about 50° C. or about 55° C. to about 60° C. for about 15 to about 20 minutes; or, the hybridization complex is washed twice with a solution with a salt concentration of about 2×SSC containing 0.1% SDS at room temperature for 15 minutes and then washed twice by 0.1×SSC containing 0.1% SDS at 68° C. for 15 minutes; or, equivalent conditions. Stringent conditions for washing can also be, e.g., 0.2×SSC/0.1% SDS at 42° C.

A specific example of stringent assay conditions is rotating hybridization at 65° C. in a salt based hybridization buffer with a total monovalent cation concentration of 1.5 M (e.g., as described in U.S. patent application Ser. No. 09/655,482 filed on Sep. 5, 2000, the disclosure of which is herein incorporated by reference) followed by washes of 0.5×SSC and 0.1×SSC at room temperature.

Stringent assay conditions are hybridization conditions that are at least as stringent as the above representative conditions, where a given set of conditions are considered to be at least as stringent if substantially no additional binding complexes that lack sufficient complementarity to provide for the desired specificity are produced in the given set of conditions as compared to the above specific conditions, where by “substantially no more” is meant less than about 5-fold more, typically less than about 3-fold more. Other stringent hybridization conditions are known in the art and may also be employed, as appropriate. Other stringent hybridization conditions are known in the art and may also be employed, as appropriate.

The array is incubated with the sample under appropriate array assay conditions, e.g., hybridization conditions, as mentioned above, where conditions may vary depending on the particular biopolymeric array and binding pair.

Once the incubation step is complete, the array is typically washed at least one time to remove any unbound and non-specifically bound sample from the substrate, generally at least two wash cycles are used. Washing agents used in array assays are known in the art and, of course, may vary depending on the particular binding pair used in the particular assay. For example, in those embodiments employing nucleic acid hybridization, washing agents of interest include, but are not limited to, salt solutions such as sodium, sodium phosphate (SSP) and sodium, sodium chloride (SSC) and the like as is known in the art, at different concentrations and which may include some surfactant as well.

Following the washing procedure, the array may then be interrogated or read to detect any resultant surface bound binding pair or target/probe complexes, e.g., duplex nucleic acids, to obtain signal data related to the presence of the surface bound binding complexes, i.e., the label is detected using calorimetric, fluorimetric, chemiluminescent, bioluminescent means or other appropriate means. The obtained signal data from the reading may be in any convenient form, i.e., may be in raw form or may be in a processed form.

As such, in using an array, the array will typically be exposed to a sample (for example, a fluorescently labeled analyte, e.g., protein containing sample) and the array then read. Reading of the array to obtain signal data may be accomplished by illuminating the array and reading the location and intensity of resulting fluorescence (if such methodology was employed) at each feature of the array to obtain a result. For example, an array scanner may be used for-this purpose that is similar to the Agilent MICROARRAY SCANNER available from Agilent Technologies, Palo Alto, Calif. Other suitable apparatus and methods for reading an array to obtain signal data are described in U.S. Patent Publication No. 20020160369 “Reading Multi-Featured Arrays” by Dorsel et al.; and U.S. Pat. No. 6,406,849 “Interrogating Multi-Featured Arrays” by Dorsel et al., the disclosures of which are herein incorporated by reference. However, arrays may be read by any other method or apparatus than the foregoing, with other reading methods including other optical techniques (for example, detecting chemiluminescent or electroluminescent labels) or electrical techniques (where each feature is provided with an electrode to detect hybridization at that feature in a manner disclosed in U.S. Pat. No. 6,221,583, the disclosure of which is herein incorporated by reference, and elsewhere).

Specific hybridization assays of interest which may be practiced using the subject arrays include: gene discovery assays, differential gene expression analysis assays; nucleic acid sequencing assays, and the like. Patents describing methods of using arrays in various applications include: U.S. Pat. Nos. 5,143,854; 5,288,644; 5,324,633; 5,432,049; 5,470,710; 5,492,806; 5,503,980; 5,510,270; 5,525,464; 5,547,839; 5,580,732; 5,661,028; 5,800,992; the disclosures of which are herein incorporated by reference.

Other array assays of interest include those where the arrays are arrays of polypeptide binding agents, e.g., protein arrays, where specific applications of interest include analyte detection/proteomics applications, including those described in U.S. Pat. Nos. 4,591,570; 5,171,695; 5,436,170; 5,486,452; 5,532,128; and 6,197,599; as well as published PCT application Nos. WO 99/39210; WO 00/04832; WO 00/04389; WO 00/04390; WO 00/54046; WO 00/63701; WO 01/14425; and WO 01/40803; the disclosures of the United States priority documents of which are herein incorporated by reference.

In certain embodiments, the results of the array reading (processed or not) may be forwarded (such as by communication) to a remote location if desired, and received there for further use (such as further processing). By “remote location” is meant a location other than the location at which the sample evaluation device is present and sample evaluation occurs. For example, a remote location could be another location (e.g., office, lab, etc.) in the same city, another location in a different city, another location in a different state, another location in a different country, etc. As such, when one item is indicated as being “remote” from another, what is meant is that the two items are at least in different buildings, and may be at least one mile, ten miles, or at least one hundred miles apart. “Communicating” information means transmitting the data representing that information as electrical signals over a suitable communication channel (for example, a private or public network). “Forwarding” an item refers to any means of getting that item from one location to the next, whether by physically transporting that item or otherwise (where that is possible) and includes, at least in the case of data, physically transporting a medium carrying the data or communicating the data. The data may be transmitted to the remote location for further evaluation and/or use. Any convenient telecommunications means may be employed for transmitting the data, e.g., facsimile, modem, Internet, etc.

APPARATUSES

Apparatuses for practicing the subject methods are also provided. In general, apparatuses are configured to direct a light source at a droplet-coated substrate surface and observe, photograph or otherwise record an image of light scattered from the substrate surface.

Embodiments include an apparatus for evaluating a quality of a surface of a substrate that includes an element for producing a plurality of droplets on a substrate surface. The droplet-producing element may be any element capable of producing droplets of liquid on a substrate surface, as described above (e.g., fog generator element 20 of FIG. 1). Other droplet-producing elements may include, but are not limited to, elements capable of generating a fog by ultrasonically agitating a liquid, by creating and directing steam over dry ice, by condensation of vapor-phase liquids on a substrate surface, by employing technology analogous to ink-jet printing, and the like. For example, a droplet-producing element may be one that is capable of providing a liquid at a vapor phase (e.g., vapor of deionized water) such that the liquid is condensed on a substrate surface when the substrate is exposed to the liquid's vapor phase. Apparatuses may also include a chamber capable of regulating the humidity the substrate is exposed to. In certain embodiments a cooling element (e.g., a peltier cooler or the like) may be provided, e.g., to maintain the substrate at a particular temperature (for example a temperature to promote condensation on a surface of the substrate). The cooling element may be a controllable cooling element, e.g., manually or automatically controllable, to maintain a substrate one or more times (i.e., increased and/or decreased) throughout a modulation protocol so as to obtain optimal contrast and imaging of the substrate surface. For example, when a certain contrast level is reached, the temperature of the substrate may be modulated to maintain that contrast, e.g., to prevent the droplets from merging together and thus increasing in size which would reduce the resolution of the captured image. For example, once a particular contrast level is reached, a cooling element may be adjusted, manually or automatically, to increase and/or decrease the temperature the substrate is exposed to and in certain embodiments the temperature the substrate is exposed to may be continually adjusted such as continually increased and decreased to maintain a particular contrast level. As noted above, smaller droplets will generally provide better or more useful images. However, if the. droplets are too small, the optical effect will not provide enough contrast to give a useful image. The optimal drop size is therefore a size that provides sufficient contrast for the optical system used to capture the image. Accordingly, mechanisms such as substrate temperature and the like may be used to maintain certain droplet sizes and thus sufficient contrast.

Apparatuses may also include a substrate station (also referred to as a substrate holder) on which a substrate may be mounted and retained. Pins or similar mechanisms may be provided on a substrate station by which to approximately align a substrate to a nominal position thereon. A substrate station may include a vacuum chuck or the like connected to a suitable vacuum source to retain a substrate without exerting too much pressure thereon, since a substrate may be made of glass in certain embodiments. A substrate holder may be operatively associated with a transporter system that enables movement of the substrate in precise relation to one or more other elements, e.g., capable of precisely controlling the position of the substrate in relation to a droplet-producing element and/or an element for observing the optical properties of from the substrate surface with respect to a substrate surface (an XYZ translational mechanism or the like). For example, droplets may be delivered from a droplet-producing element onto the substrate while the substrate is advanced beneath it by a transporter or the like, all under control of a processor. Alternatively or in addition to advancing the substrate, the droplet-producing element may also be advanced across the substrate surface. A transporter system may include a carriage connected to a transporter controlled by a processor. An encoder may be provided that communicates with the processor to provide data on the exact location of the substrate station (and hence the substrate. if positioned correctly on the substrate station), while the encoder provides data on the exact location of the droplet-producing element. Any suitable encoder, such as an optical encoder, may be used which provides data on linear position.

Apparatuses may also include an element for observing optical properties from the substrate surface. The optical property-observing element may be any suitable element such as a microscope, camera, and the like, capable of providing an image (which may or may not be a magnified image) of an observed substrate surface. In certain embodiments, the optical property-observing element is capable of recording a digital image of a substrate surface such as a camera or the like such that the variations of light (if any) from the substrate surface are captured by the digital image. For example, embodiments may include a camera having a suitable lens for imaging and recording optical properties such as light scattered from the substrate surface. For example, a camera with a self-calibrating 12:1 programmable zoom lens (which may or may not include optional attachment lenses such as 0.5×, 1.5×, 2.0×, and the like, lens attachments) may be used. Any suitable microscope, camera or analogous imaging device may be employed, e.g., a color CCD camera with 768×494 array, a grayscale CCD with 768×494 array, or the like. In certain embodiments, commercially available video microscope systems may be adapted for use with the subject apparatuses, e.g., SmartScope® video measuring systems available from Optical Gaging Products, Inc., and the like.

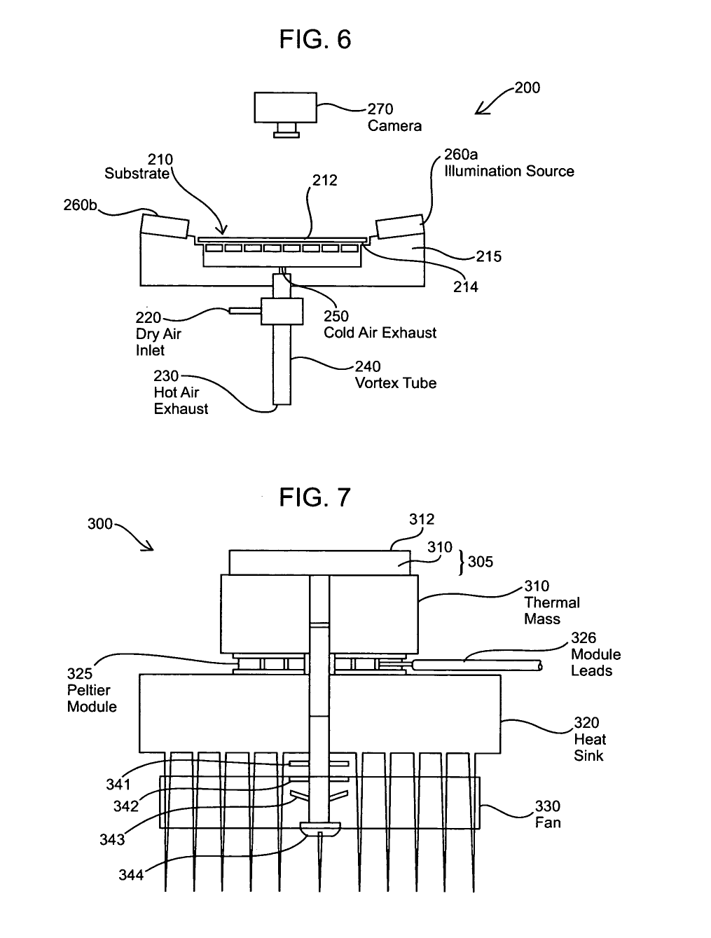

A cross sectional view of an exemplary apparatus 200 according to the subject invention is shown in FIG. 6. Apparatus 210 includes an element for producing a plurality of droplets (not shown) analogous to that described with respect to FIG. 1. For example, a water vapor generator (steam generator) may be employed to produce a jet of humid gas that is directed at a chilled substrate surface. The droplet producing element may be a hand-held unit or may be a capable of providing a continual cross-flow of steam and may be integrated with the apparatus as a single unit. Substrate 210 is positioned on substrate holder 215 apparatus 200 of FIG. 7 and is cooled by a chilled flow of dry gas such as nitrogen or dry air via dry air inlet 220. A vortex tube 240 is used for chilling the gas in this embodiment, although other mechanisms may be employed. While the flow of cool gas across the backside 214 of substrate 210 chills the substrate, it prevents condensation on the backside because the dry air absorbs any water. The water vapor provided by a suitable source condenses on the front surface 212 of substrate 210 producing a plurality of droplets on surface 212. Also provided are cold air exhaust 250 and hot air exhaust 230. Apparatus 200 includes at least two illumination sources 260a and 260b positioned at two edges of substrate 210 to uniformly illuminate surface 212 from oblique angles. Camera 270 records light scattered from the substrate surface.

FIG. 7 shows another exemplary embodiment of an apparatus that may be employed in the practice of the subject methods. Apparatus 300 includes peltier module 325 having leads 326 and thus may be characterized as a peltier assembly. Peltier assembly 300 includes thermal mass or holder 310, heat sink 320 and fan 330. Heat insulating washer 341 is employed, as well as flat washer 343 and belville washer 344. A screw or analogous mechanism is used to maintain the assembly together.

SYSTEMS

The subject invention also includes systems that may be employed in the practice of the subject invention. Systems may include an apparatus for evaluating a quality of a substrate surface, as described above, and a substrate to be evaluated. As described above, the substrate may be any suitable substrate and may or may not include one or more arrays thereon.

KITS

Finally, kits for use in practicing the subject invention are also provided. The subject kits may include at least one array assembly that has been evaluated according to the subject methods. For example, the substrate, without the one or more arrays may have been evaluated and/or a substrate with the one or more arrays may have been evaluated. The kits may further include one or more additional components necessary for carrying out an analyte detection assay, such as sample preparation reagents, buffers, labels, and the like. As such, the kits may include one or more containers such as vials or bottles, with each container containing a separate component for the assay, and reagents for carrying out an array assay such as a nucleic acid hybridization assay or the like. The kits may also include a denaturation reagent for denaturing the analyte, buffers such as hybridization buffers, wash mediums, enzyme substrates, reagents for generating a labeled target sample such as a labeled target nucleic acid sample, negative and positive controls.

In addition to one or more biopolymeric array assemblies, the subject kits may also include written instructions for using the biopolymeric arrays in array assays such as hybridization assays or protein binding assays. The instructions may be printed on a substrate, such as paper or plastic, etc. As such, the instructions may be present in the kits as a package insert, in the labeling of the container of the kit or components thereof (i.e., associated with the packaging or sub-packaging) etc. In other embodiments, the instructions are present as an electronic storage data file present on a suitable computer readable storage medium, e.g., CD-ROM, diskette, etc. In yet other embodiments, the actual instructions are not present in the kit, but means for obtaining the instructions from a remote source, e.g. via the Internet, are provided. An example of this embodiment is a kit that includes a web address where the instructions can be viewed and/or from which the instructions can be downloaded. As with the instructions, this means for obtaining the instructions is recorded on a suitable substrate.

Kits may also include components for evaluating a quality of a substrate surface. For example, a kit may include one or more of the following: a fogging device or other device for producing droplets on a substrate surface, a liquid or liquid mixture for producing droplets such as by fogging, an illumination device, a cooling device, a fixture to hold the substrate (which fixture may (or may not) include the illumination and cooling devices), a device for observing and/or recording the image (such as a film or digital camera), a device and/or software program or algorithm recorded on a computer readable medium to evaluate the image, and instructions for evaluating a quality of a substrate surface. The instructions may be printed on a substrate, such as paper or plastic, etc. As such, the instructions may be present in the kits as a package insert, in the labeling of the container of the kit or components thereof (i.e., associated with the packaging or sub-packaging) etc. In other embodiments, the instructions are present as an electronic storage data file present on a suitable computer readable storage medium, e.g., CD-ROM, diskette, etc. In yet other embodiments, the actual instructions are not present in the kit, but means for obtaining the instructions from a remote source, e.g. via the Internet, are provided. An example of this embodiment is a kit that includes a web address where the instructions can be viewed and/or from which the instructions can be downloaded. As with the instructions, this means for obtaining the instructions is recorded on a suitable substrate.

In many embodiments of the subject kits, the components of the kit are packaged in a kit containment element to make a single, easily handled unit, where the kit containment element, e.g., box or analogous structure, may or may not be an airtight container, e.g., to further preserve the one or more biopolymeric arrays and reagents, if present, until use.

### EXPERIMENTAL

The following examples are put forth so as to provide those of ordinary skill in the art with a complete disclosure and description of how to make and use the present invention, and are not intended to limit the scope of what the inventors regard as their invention. Efforts have been made to ensure accuracy with respect to numbers used (e.g. amounts, temperature, etc.) but some experimental errors and deviations should be accounted for. Unless indicated otherwise, parts are parts by weight, molecular weight is weight average molecular weight, temperature is in degrees Centigrade, and pressure is at or near atmospheric.

In the following examples, a substrate surface was evaluated according to the subject methods. In the examples 1 and 2, substrate surfaces that do not include arrays were evaluated. In examples 3 and 4, the substrate surfaces evaluated include unhybridized array features.

### Example 1

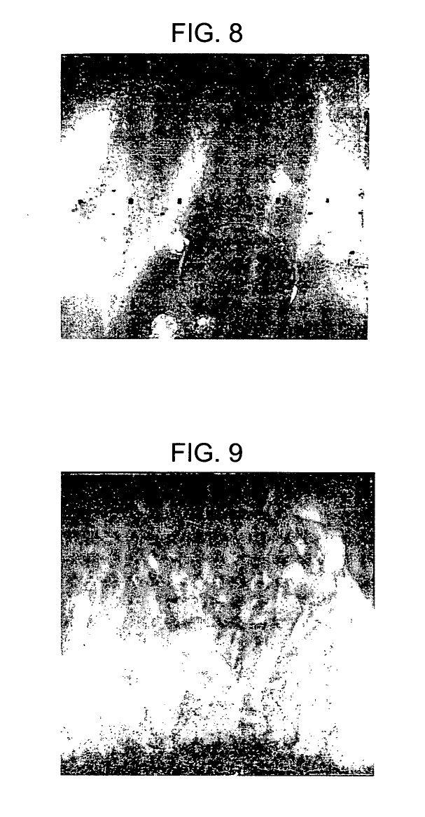

In this example, a glass substrate was fogged such that a plurality of droplets were produced on the substrate surface. The fogged surface was then illuminated with light and a digital image from the fogged, illuminated surface was obtained. FIG. 8 shows the obtained image which shows variations in light obtained from the substrate surface, i.e., various bright and dark areas. The areas of relative brightness indicate areas of contamination on the glass surface which were not visible to the naked eye. Also now observable is residue from a suction cup used to handle the glass during a manufacturing process. Accordingly, the subject methods effectively identified contamination of the substrate.

### Example 2

In this example, a glass substrate having a silylated coating was fogged such that a plurality of droplets were produced on the silylated surface. The fogged surface was then illuminated with light and a digital image from the fogged, illuminated surface was obtained. FIG. 9 shows the obtained image which shows variations in light obtained from the substrate surface, i.e., various bright and dark areas. The areas of relative brightness indicate areas of non-uniformity of the silylated coating which was not visible to the naked eye. Accordingly, the subject methods effectively identified non-uniformity of the silylated coating of the substrate.

### Example 3

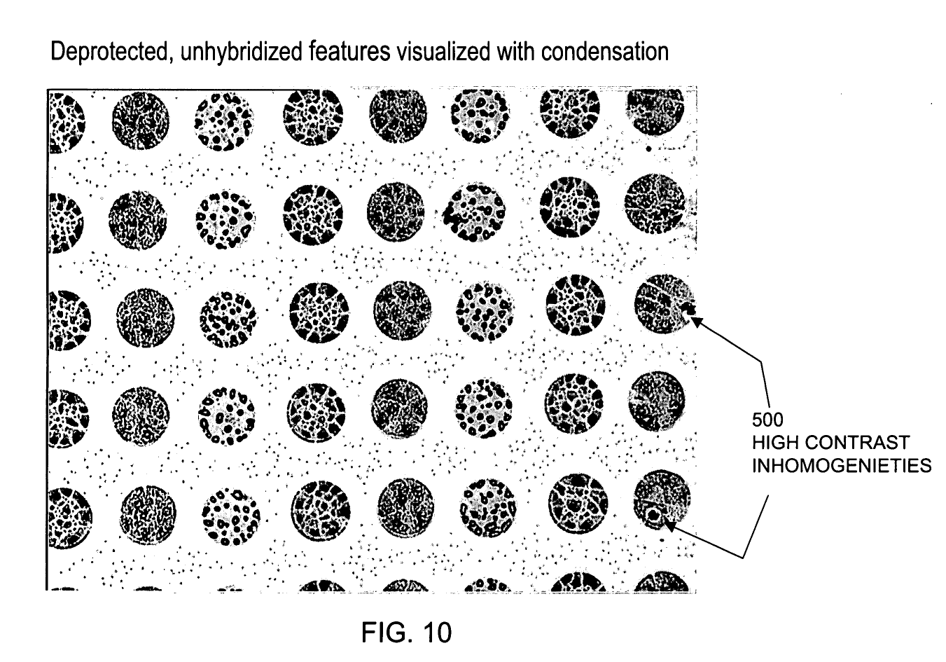

In this example, a substrate having deprotected, unhybridized nucleic acid array features thereon was fogged such that a plurality of droplets were produced on the substrate surface. The fogged surface was then illuminated with light and a digital image from the fogged, illuminated surface was obtained. FIG. 10 shows the obtained image which shows variations in light obtained from the substrate surface, i.e., various bright and dark areas. The image shows high contrast inhomogeneties (e.g., inhomogeneties 500) can be linked to defects in the array features, which defects were not visible to the naked eye. Accordingly, the subject methods effectively identified non-uniformity of the features.

### Example 4

this example, a substrate having unhybridized nucleic acid array features thereon was fogged such that a plurality of droplets were produced on the substrate surface. The fogged surface was then illuminated with light and a digital image from the fogged, illuminated surface was obtained. FIG. 10 shows the obtained image which shows variations in light obtained from the substrate surface, i.e., various bright and dark areas. The single droplet covering each feature exhibits a high contrast ring (see for example ring 600) that that may be measured. Evaluation of the ring 600, or any other optical feature, provided by interaction of the fluid droplet of the same or similar size as the feature, may be used to provide uniformity information of the underlying feature, i.e., the uniformity of the bright ring is analogous to the feature uniformity. As shown from this image, some of the features are not uniform, which non-uniformity was not visible to the naked eye. Accordingly, the subject methods effectively identified non-uniformity of the features.

It is evident from the above results and discussion that the above-described invention provides methods and devices that evaluate a quality of a substrate surface. Accordingly, methods and devices are provided that provide high resolution images of surface energy variations over large areas, are inexpensive to implement, are non-destructive, easy and quick to use, and which can be used to immediately visualize the uniformity of manufacturing process such as cleaning and coating surface, and the like, as well as uniformity of an array. As such, the subject invention represents a significant contribution to the art.

All publications and patents cited in this specification are herein incorporated by reference as if each individual publication or patent were specifically and individually indicated to be incorporated by reference. The citation of any publication is for its disclosure prior to the filing date and should not be construed as an admission that the present invention is not entitled to antedate such publication by virtue of prior invention.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

1. A method of evaluating a quality of a surface of a substrate, said method comprising:
(a) producing a plurality of droplets on said surface of said substrate;
(b) illuminating said droplet-coated surface;
(c) observing a resultant optical property from said surface; and
(d) evaluating a quality of said substrate based on said observed optical property.

2. The method of claim 1, wherein said plurality of droplets are aqueous droplets.

3. The method of claim 2, wherein said aqueous droplets are pure water.

4. The method of claim 1, wherein said resultant optical property include at least one of refraction, reflection and diffusion.

5. The method of claim 4, wherein said quality is uniformity.

6. The method of claim 5, wherein said uniformity is observed as variations in light.

7. The method of claim 5, wherein said method comprises evaluating uniformity of surface energies.

8. The method of claim 7, wherein said method comprises determining contact angles between said substrate surface and said droplets.

9. The method of claim 1, wherein said substrate is a substrate to be used in the fabrication of an array assembly and said method is performed prior to fabricating an array on said substrate surface.

10. The method of claim 9, further comprising, after said observing step, fabricating at least one array on said substrate surface.

11. The method of claim 1, wherein said substrate comprises at least one array on said surface and said method is performed subsequent to fabricating an array on said substrate surface.

12. The method of claim 11, wherein said quality is uniformity of features of said array.

13. The method of claim 1, wherein said observing comprises producing an image of said observed optical properties.

14. A method of fabricating an array on a substrate surface, said method comprising:
(a) producing a plurality of droplets on said surface of said substrate;
(b) illuminating said droplet coated surface;
(c) observing a resultant optical property from said surface to evaluate a quality of said substrate based on said observed optical property; and
(d) fabricating at least one array on said substrate surface either before step (a) or after step (c).

15. A method of evaluating a quality of an array present on a substrate surface, said method comprising:
(a) producing a plurality of droplets on said surface of said substrate;
(b) illuminating said droplet-coated surface; and
(c) observing a resultant optical property from said surface to evaluate a quality of said array based on said observed optical property.

16. The method of claim 15, comprising, after said quality has been evaluated, contacting said fabricated array with a sample under conditions suitable for an array assay.

17. The method of claim 16, further comprising reading said at least one array.

18. A method comprising receiving from a remote location a result of a reading performed by a method of claim 17.

19. A method comprising forwarding to a remote location a result of a reading performed by a method of claim 17.

20. An apparatus for evaluating a quality of a surface of a substrate, said apparatus comprising:
an element for producing a plurality of droplets on said substrate surface;
a substrate holder for holding said substrate surface in operative relation to said droplet producing element; and
an element for observing an optical property from said substrate surface.

21. A system for determining a quality of a surface of a substrate, said system comprising:
(a) a substrate; and
(b) an apparatus according to claim 20.

22. A kit comprising:
(a) an array assembly comprising a substrate having a surface and at least one array present on a surface of said substrate, wherein a quality of said substrate has been evaluated according to the method of claim 1 before, after or before and after said array has been positioned on said substrate surface; and
(b) instructions for using said array assembly in an array assay.
